(19) United States
(12) Patent Application Publication
(10) Pub. No.: US 2026/0029929 A1
(43) Pub. Date: Jan. 29, 2026

(54) Sub Block Access via Configuring a Data Size of Logical Block Addressing in a Memory Sub-System

(71) Applicant: Micron Technology, Inc., Boise, ID (US)

(72) Inventors: Steven Wells, Sacramento, CA (US); Suresh Rajgopal, San Diego, CA (US)

(21) Appl. No.: 19/255,893

(22) Filed: Jun. 30, 2025

Related U.S. Application Data
(60) Provisional application No. 63/676,613, filed on Jul. 29, 2024.

(51) Int. Cl. G06F 3/06

(52) U.S. Cl. CPC G06F 3/0619; G06F 3/064; G06F 3/0659; G06F 3/0679

(57) ABSTRACT

A computing system having a host system connected to a memory sub-system via a computer bus. In response to the host system sending a first command configured to identify a first logical block addressing data size at a block level, the memory sub-system can format data storage for a namespace in a non-volatile memory at the block level. In response to the host system sending a second command configured to identify a second logical block addressing data size at a sub block level, the memory sub-system can configure access to the namespace at the second logical block addressing data size without changing the data storage in the non-volatile memory for the namespace at the block level.

### RELATED APPLICATIONS

The present application claims priority to Prov. U.S. pat. app. Ser. No. 63/676,613 filed Jul. 29, 2024, the entire disclosures of which application are hereby incorporated herein by reference.

### TECHNICAL FIELD

At least some embodiments disclosed herein relate to memory systems in general, and more particularly, but not limited to memory systems operable to support access at block level and at sub block level.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates an example computing system having a host system and a memory sub-system configured in accordance with some embodiments of the present disclosure.

FIG. 2 shows a technique to access sub blocks via LBA data size being configured to match with the size of a sub block according to one embodiment.

FIG. 3 shows an access command configured according to one embodiment.

FIG. 4 shows a structure of identify namespace data according to one embodiment.

FIG. 5 shows an LBA format data according to one embodiment.

FIG. 6 shows a format command according to one embodiment.

FIG. 7 illustrates an example of changing data size of LBA to facilitate sub block access according to one embodiment.

FIG. 8 to FIG. 9 show methods for sub block access according to some embodiments.

FIG. 10 is a block diagram of an example computer system in which embodiments of the present disclosure can operate.

### DETAILED DESCRIPTION

At least some aspects of the present disclosure are directed to techniques of a memory sub-system providing access at a sub block level and at a block level. For example, data can be stored in the memory sub-system with error correction code (ECC) protection at a block level (e.g., for improved efficiency in error correction code (ECC) operations); and the stored data can be accessed at a sub block level using a logical block addressing (LBA) data size that matches with the size of a sub block.

A conventional memory sub-system (e.g., a solid-state drive in compliance with a non-volatile memory express (NVMe) standard) can include a flash memory (e.g., NAND memory) that is to be in an erased state before being programmed to store data. For example, such a flash memory can include memory cells formed in an integrated circuit die and structured in pages of memory cells, blocks of pages, and planes of blocks. A page of memory cells is configured to be programmed together to store data in an atomic operation of programming memory cells. A block of memory cells can have a plurality of pages, which are configured to be erased together in an atomic operation of erasing memory cells. It is not operable to perform an operation to erase some pages in a block without erasing other pages in the same block. However, the pages in a block can be programmed separately. A plane of memory cells can have a plurality of blocks. In some implementations, planes of memory cells have the same structure such that a same operation (e.g., read, write) can be performed in parallel in multiple planes.

A conventional host system is configured (e.g., according to an NVMe standard) to instruct the memory sub-system to store data at locations specified via logical block addresses (e.g., LBA addresses). Each logical block address identifies a block of storage space that can be implemented using the storage capacity of one or more pages of memory cells. For example, a typical size of the storage space represented by a logical block address in a solid-state drive (SSD) is 512 bytes (or larger, e.g., 4 KB). The memory sub-system (e.g., SSD) can have a flash translation layer configured to map the logical block addresses as known to the host system to physical addresses of memory cells in the memory sub-system. As a result, the host system does not have to be aware which data items are stored in which particular memory cells.

There can be a problem of read amplification over a computer bus (e.g., a peripheral component interconnect express (PCIe) bus) and memory amplification in a host system accessing a non-volatile memory sub-system, such as a block storage device implemented in according to a standard of non-volatile memory express (NVMe).

For example, in some classes of storage usages the data being accessed has a spatial locality (also known as the granularity of the data) that is smaller than the size of an NVMe logical block. Examples of such data of small spatial locality include graph structure and massive deep learning recommendation models (DLRMs). A graph structure is configured to identify each vertex in a graph via a list of vertices. In traversing the graph, certain vertices can be selectively accessed; and the size of data about each vertex can be smaller than the size (e.g., 512 bytes or more) of an NVMe logical block represented by each LBA address. Massive DLRMs can have many tables; and the majority of the tables used in inference computations can have embedding dimension smaller than 512 bytes.

Consider, for example, an NVMe logical block having a size of 4096 bytes, while the data to be used from this block has the size of 128 bytes. It is inefficient to move the block of 4096 bytes from a solid-state drive across a PCIe bus to the memory of the host system only to use 128 bytes of the block of 4096 bytes. The portion of the block outside of the 128 bytes being used only increases the memory usage in the host system. The block level access at 4096 bytes a block increases read amplification (e.g., data transferred over the PCIe bus being more than the data needed at the host system), and increases memory amplification (e.g., the amount of memory used for the read being more than the amount of useful data in the memory allocated for the read).

At least some techniques provided in the present disclosure address the above and other deficiencies and challenges by facilitating sub block read/write with transferring only the useful data contained within a portion of a block, without transferring the data of the block outside of the portion. Sub block access allows the host system to allocate its memory to hold the useful part of the data in a block (instead of allocating its memory for the entire block).

In one embodiment, sub block read and write can be performed using an NVMe memory namespace command set, where read and write commands have a sub block granularity resulting from the use of an LBA data size that matches with the size of a sub block.

For example, when an NVMe namespace is created, the NVMe namespace can have an LBA data size that is at a block level (e.g., 512 bytes, or more, of data storage space for each LBA address). To enable sub block access, the LBA data size of the namespace can be reduced to a sub block level (e.g., 128 bytes, or less, of data storage space for each LBA address). The memory sub-system can change its LBA data size between the block level and the sub block level without changing the low level storage of data at the block level. Based on a ratio between the block-level LBA data size (e.g., 512 bytes or more) of the block level and the sub block-level LBA data size (e.g., 128 bytes or less), the memory sub-system can map the sub block-level LBA address to the block-level LBA address to access the corresponding block stored in the storage media. An entire ECC protected block corresponding to the block-level LBA address can be retrieved from the memory cells for error detection and correction using an ECC technique. The ECC decoded block can be buffered in a random access memory of the memory sub-system. From the sub block-level LBA address, the memory sub-system can determine a sub block within the buffered block. A read operation at the sub block-level LBA address can be performed via extracting the sub block from the block buffered in the random access memory; and a write operation at the sub block-level LBA address can be performed via modifying the sub block in the block buffered in the random access memory according to the data to be written at the sub block-level LBA address. The modified block in the random access memory can be subsequently stored into the memory cells of the memory sub-system with ECC protection at the block level.

Thus, when the LBA address is configured to have a sub-block data size, the memory sub-system can execute an access command according to the LBA address identified in the command to transfer a sub block of data stored with ECC protection at a block level, without transferring data, over a connection between the host system and the memory sub-system (e.g., PCI bus), that is outside of the sub block, as discussed in further details below.

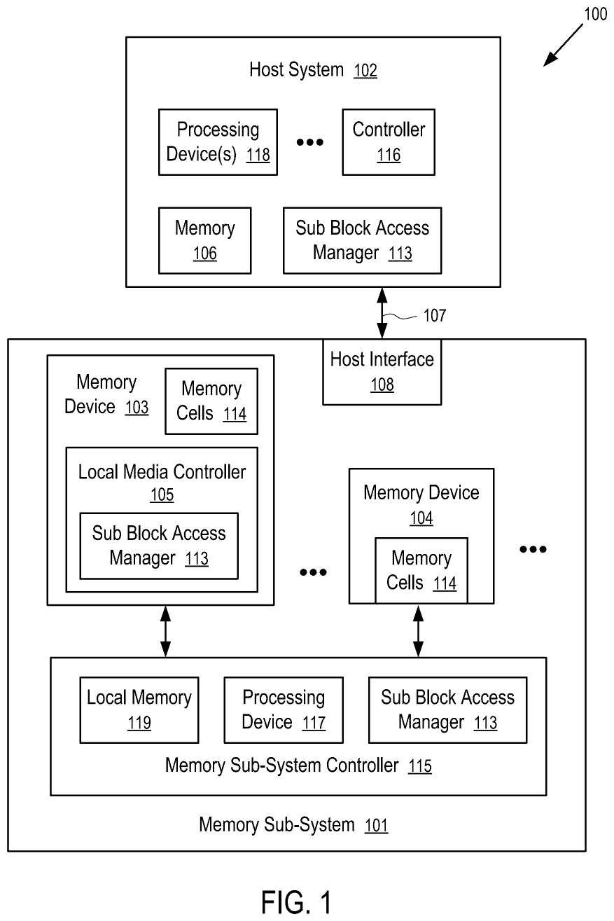

FIG. 1 illustrates an example computing system 100 that includes a memory sub-system 101 in accordance with some embodiments of the present disclosure. The memory sub-system 101 can include media, such as one or more volatile memory devices (e.g., memory device 104), one or more non-volatile memory devices (e.g., memory device 103), or a combination of such.

In general, a memory sub-system 101 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 102 that is coupled to one or more memory sub-systems 101. FIG. 1 illustrates one example of a host system 102 coupled to one memory sub-system 101. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system 102 can include a processor chipset (e.g., processing device 118) and a software stack executed by the processor chipset. The processor chipset can include one or more cores, one or more caches, a memory controller (e.g., controller 116) (e.g., NVDIMM controller), and a storage protocol controller (e.g., PCIe controller, SATA controller). The host system 102 uses the memory sub-system 101, for example, to write data to the memory sub-system 101 and read data from the memory sub-system 101.

The host system 102 can be coupled (e.g., over a computer bus 107) to the memory sub-system 101 via a physical host interface 108. Examples of a physical host interface 108 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface 108 can be used to transmit data between the host system 102 and the memory sub-system 101. The host system 102 can further utilize an NVM express (NVMe) interface to access components (e.g., memory devices 103) when the memory sub-system 101 is coupled with the host system 102 by the PCIe interface. The physical host interface 108 can provide an interface for passing control, address, data, and other signals between the memory sub-system 101 and the host system 102. FIG. 1 illustrates a memory sub-system 101 as an example. In general, the host system 102 can access multiple memory sub-systems via a same communication connection, multiple separate communication connections, and/or a combination of communication connections.

The processing device 118 of the host system 102 can be, for example, a microprocessor, a central processing unit (CPU), a processing core of a processor, an execution unit, etc. In some instances, the controller 116 can be referred to as a memory controller, a memory management unit, and/or an initiator. In one example, the controller 116 controls the communications over a bus coupled between the host system 102 and the memory sub-system 101. In general, the controller 116 can send commands or requests to the memory sub-system 101 for desired access to memory devices 103, 104. The controller 116 can further include interface circuitry to communicate with the memory sub-system 101. The interface circuitry can convert responses received from the memory sub-system 101 into information for the host system 102.

The controller 116 of the host system 102 can communicate with the controller 115 of the memory sub-system 101 to perform operations such as reading data, writing data, or erasing data at the memory devices 103, 104 and other such operations. In some instances, the controller 116 is integrated within the same package of the processing device 118. In other instances, the controller 116 is separate from the package of the processing device 118. The controller 116 and/or the processing device 118 can include hardware such as one or more integrated circuits (ICs) and/or discrete components, a buffer memory, a cache memory, or a combination thereof. The controller 116 and/or the processing device 118 can be a microcontroller, special purpose logic circuitry (e.g., a field programmable gate array (FPGA), an application specific integrated circuit (ASIC), etc.), or another suitable processor.

The memory devices 103, 104 can include any combination of the different types of non-volatile memory components and/or volatile memory components. The volatile memory devices (e.g., memory device 104) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 103 can include one or more arrays of memory cells 114. One type of memory cells, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 103 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells 114 of the memory devices 103 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 103 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 103 to perform operations such as reading data, writing data, or erasing data at the memory devices 103 and other such operations (e.g., in response to commands scheduled on a command bus by controller 116). The controller 115 can include hardware such as one or more integrated circuits (ICs) and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (processor) configured to execute instructions stored in a local memory 119. In the illustrated example, the local memory 119 of the controller 115 includes an embedded memory configured to store instructions for performing various processes, operations, logic flows, and routines that control operation of the memory sub-system 101, including handling communications between the memory sub-system 101 and the host system 102.

In some embodiments, the local memory 119 can include memory registers storing memory pointers, fetched data, etc. The local memory 119 can also include read-only memory (ROM) for storing micro-code. While the example memory sub-system 101 in FIG. 1 has been illustrated as including the controller 115, in another embodiment of the present disclosure, a memory sub-system 101 does not include a controller 115, and can instead rely upon external control (e.g., provided by an external host, or by a processor or controller separate from the memory sub-system).

In general, the controller 115 can receive commands or operations from the host system 102 and can convert the commands or operations into instructions or appropriate commands to achieve the desired access to the memory devices 103. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 103. The controller 115 can further include host interface circuitry to communicate with the host system 102 via the physical host interface 108. The host interface circuitry can convert the commands received from the host system into command instructions to access the memory devices 103 as well as convert responses associated with the memory devices 103 into information for the host system 102.

The memory sub-system 101 can also include additional circuitry or components that are not illustrated. In some embodiments, the memory sub-system 101 can include a cache or buffer (e.g., DRAM) and address circuitry (e.g., a row decoder and a column decoder) that can receive an address from the controller 115 and decode the address to access the memory devices 103.

In some embodiments, the memory devices 103 include local media controllers 105 that operate in conjunction with the memory sub-system controller 115 to execute operations on one or more memory cells of the memory devices 103. An external controller (e.g., memory sub-system controller 115) can externally manage the memory device 103 (e.g., perform media management operations on the memory device 103). In some embodiments, a memory device 103 is a managed memory device, which is a raw memory device combined with a local controller (e.g., local media controller 105) for media management within the same memory device package. An example of a managed memory device is a managed NAND (MNAND) device.

The controller 115 and/or a memory device 103 can include a sub block access manager 113 configured to perform operations related to accessing the memory sub-system 101 at a granularity level lower than the size of a block for ECC operation. In some embodiments, the controller 115 in the memory sub-system 101 includes at least a portion of the sub block access manager 113. In other embodiments, or in combination, the controller 116 and/or the processing device 118 in the host system 102 includes at least a portion of the sub block access manager 113. For example, the controller 115, the controller 116, and/or the processing device 118 can include logic circuitry implementing the sub block access manager 113. For example, the controller 115, or the processing device 118 (processor) of the host system 102, can be configured to execute instructions stored in memory for performing the operations of the sub block access manager 113 described herein. In some embodiments, the sub block access manager 113 is implemented in an integrated circuit chip disposed in the memory sub-system 101. In other embodiments, the sub block access manager 113 can be part of firmware of the memory sub-system 101, an operating system of the host system 102, a device driver, or an application, or any combination therein.

For example, the sub block access manager 113 implemented in the controller 115 and/or 105 of the memory sub-system 101 can be configured to change the LBA data size in a namespace. The LBA data size can be changed between a block size and a sub block size without changing the low level data storage in the memory sub-system 101 that is configured at the block level. When the namespace is configured with an LBA data size that a sub block level, the sub block access manager 113 can transfer data, for execution of a read or write command and between the memory 106 of the host system 102 and the memory sub-system 101 over the connection or bus 107, for a sub block according to an LBA address provided in the command, without transferring other sub blocks in the block and/or without the host system 102 allocating a portion of the memory 106 to store the sub blocks outside the block.

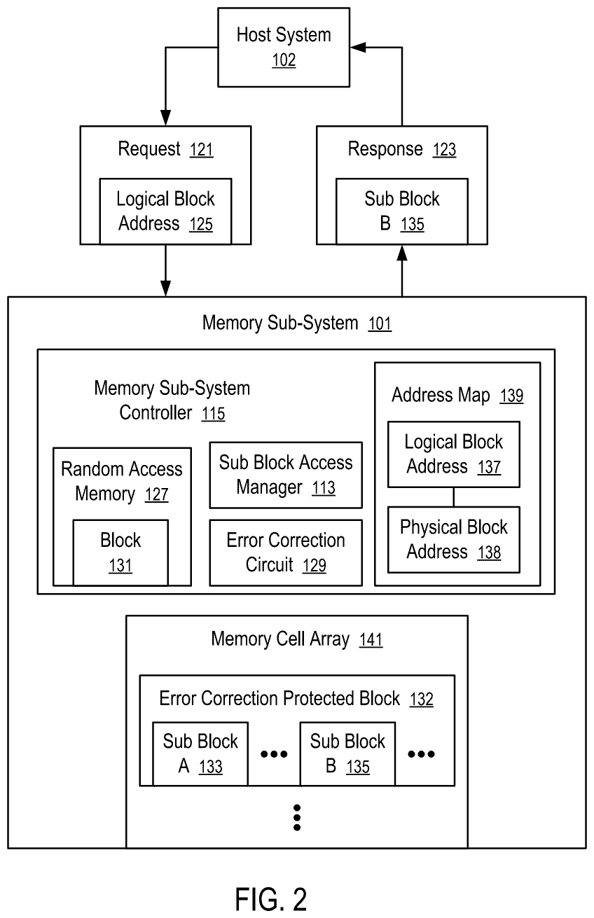

Further details of the operations of the sub block access managers 113 in the host system 102 and in the memory sub-system 101 are discussed below in connection with FIG. 2 to FIG. 10.

FIG. 2 shows a technique to access sub blocks via LBA data size being configured to match with the size of a sub block according to one embodiment. For example, the technique of FIG. 2 can be implemented in a computing system 100 of FIG. 1.

In FIG. 2, the memory sub-system 101 is configured to store data in a memory cell array 141 at the granularity level of blocks (e.g., 512 bytes per block of input data to be protected via an ECC technique).

Each error correction protected block (e.g., 132) store in the memory cell array 141 can include the content of a block 131 and redundant data. Using the redundant data the error correction circuit 129 of the controller 115 of the memory sub-system 101 can detect errors in the block 132 of data retrieved from the memory cell array 141, correct the errors, and provide the error free content of the block 131 in the random access memory 127 of the controller 115.

For example, the controller 115 of the memory sub-system 101 is configured to write the block 131 as the error correction protected block 132 in the array 141 of memory cells (e.g., 114 in a memory device 103 of the memory sub-system 101) as an atomic operation.

For example, the controller 115 of the memory sub-system 101 is configured to read the block 132 from the array 141 for decoding, using the error correction circuit 129, into a block 131 in the random access memory as an atomic operation.

The block 131 (and thus block 132) can have a plurality of sub blocks (e.g., 133, 135). For simplicity and efficiency, the block 131 can be configured to have 2^{m} sub blocks (e.g., 4, 8 or 16 sub blocks), where each sub block has a size of 2ⁿ bytes (e.g., 128 bytes) such that each block has a size of 2^{n+m} bytes, and where n and m are integers. In one embodiment, n+m is at least 9, which corresponds to a block size of at least 512 bytes.

In FIG. 2, the host system 102 can use a storage access protocol (e.g., in accordance with an NVM express NVM command set specification of 2021 and an NVM express base specification of 2024) to access the memory sub-system 101,

According to the storage access protocol, an access request 121 can specify an LBA address 125 configured in a namespace. In FIG. 2, the data size of LBA addresses (e.g., 125) in the namespace is configured at a sub block level (e.g., 2ⁿ bytes per LBA address), while the data storage and ECC protection in the memory cell array 141 is at a block level (e.g., 2^{n+m} bytes per block).

Each sub block-level LBA address (e.g., 125) as known to the host system 102 and used in an access request (e.g., 121) from the host system 102 has a data size of 2ⁿ bytes. In contrast, the memory sub-system 101 internally stores and ECC protects data in the namespace at the block granularity of 2^{n+m} bytes per block (e.g., 131), which corresponds block-level LBA addresses having LBA data size equal to 2^{n+m} bytes. The memory sub-system 115 can maintain an address map 139 that maps between block-level LBA addresses (e.g., 137) and addresses (e.g., 138) of the physical blocks (e.g., 132) in the memory cell array 141.

The memory sub-system 101 includes a sub block access manager 113 configured to perform the mapping between the sub block-level LBA address (e.g., 125) identified by the host system 102 and the block-level LBA address (e.g., 137) used in the address map 139.

In response to request 121, the sub block access manager 113 can identify a block-level LBA address 137 that contains the sub-level LBA address 125 provided in the request 121, and determine if the content of the block-level LBA address is buffered in the random access memory 127. If so, the memory sub-system 101 generate the response 123 based on a portion of the content of the block 131 that corresponds to the sub block as identified by the sub block-level LBA address 125. Otherwise, the memory sub-system 101 can retrieve the content of the block 131 from the memory cell array 141 into the random access memory 127 in response to the request 121.

For example, when the request 121 is a read request, the sub block access manager 113 in the memory sub-system 101 can extract the portion of the block 131 as the sub block 135 provided in the response 123, without transmitting the content of the block 131 that is outside of the sub block 135 identified by the logical block address 125.

Similarly, in response to a write request, the memory sub-system 101 can retrieve the content of the sub block 135 from the memory 106 of the host system 102 to modify the corresponding portion in the block 131 in accordance with the logical block address 125. Subsequently, the modified block 131 as buffered in the random access memory 127 can be written to the memory cell array 141 in an atomic operation (e.g., together with redundant data as the error correction protected block 132).

Thus, the sub block access manager 113 can perform the translation/mapping between block and sub block internally for the host system 102 on the fly, as if the data storage in the memory cell array 131 were at a sub block level.

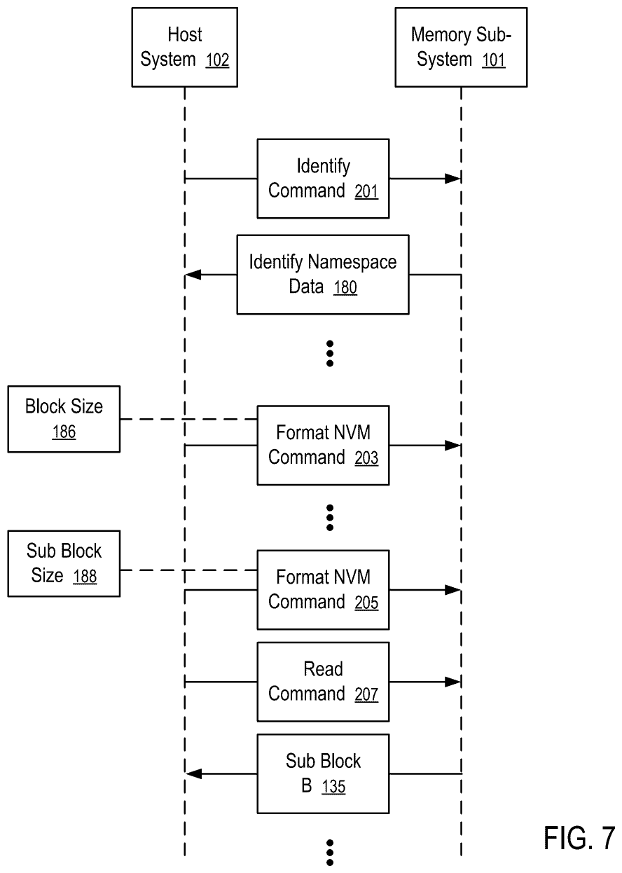

Optionally, the sub block access manager 113 in the host system 102 can send commands (e.g., format NVM commands 195 in FIG. 6) to the memory sub-system 101 to change the data size of LBA addresses used by the host system 102 to access memory sub-system 101. The sub block access manager 113 in the memory sub-system 101 can be configured to perform the translation/mapping between block and sub block in accordance with the commands.

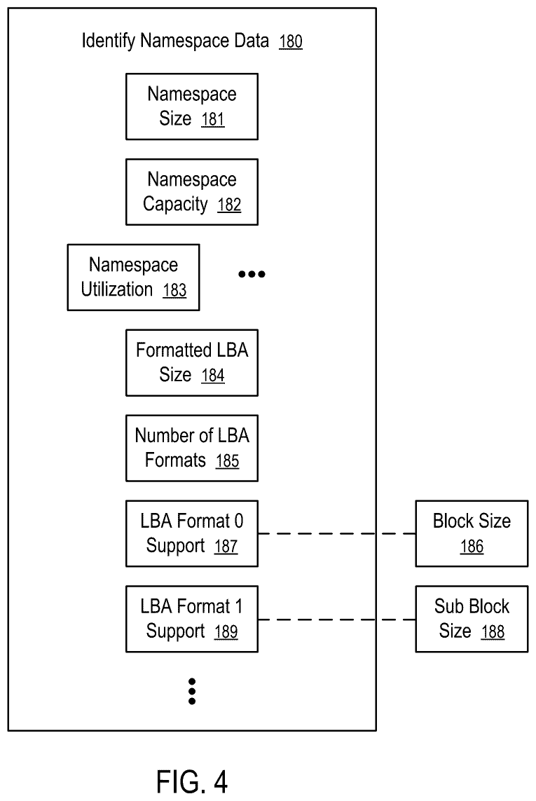

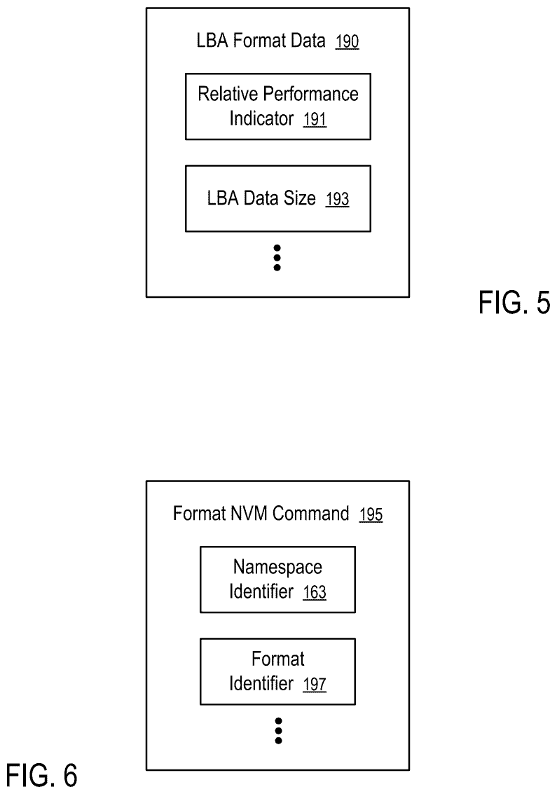

Optionally, the memory sub-system 101 can be configured to identify supported LBA formats (e.g., via identify namespace data 180 as in FIG. 4 and FIG. 5) to the host system 102 (e.g., in response to an identify command from the host system 102); and the sub block access manager 113 in the host system 102 can change or set the LBA data size based on the supported LBA formats identified by the memory sub-system 101.

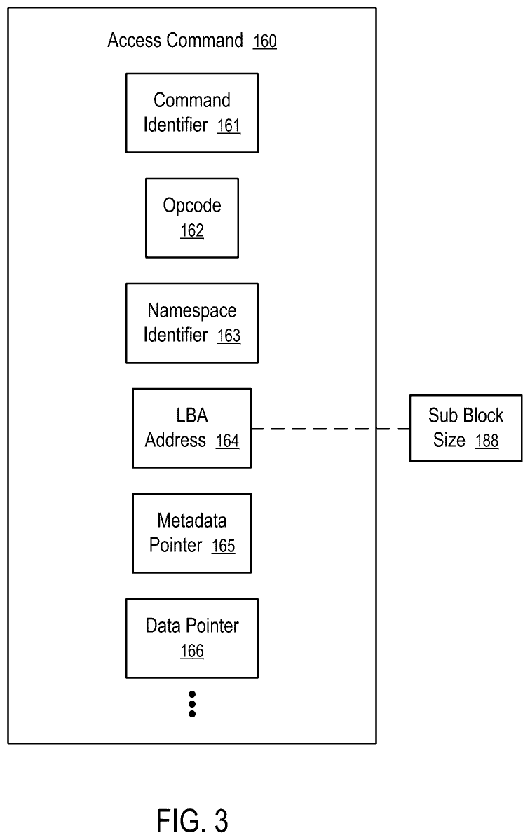

FIG. 3 shows an access command configured according to one embodiment. For example, the request 121 in FIG. 2 can be implemented using the access command of FIG. 3.

In FIG. 3, the access command 160 can have a predetermined command size (e.g., 64 bytes according to a version of NVMe standard).

The access command 160 specifies an LBA address 164 that is configured to have a data size equal to a sub block size 188 (e.g., 2ⁿ bytes). Thus, each sub block (e.g., 135) in the storage space of the namespace represented by an identifier 163 can be represented by an LBA address (e.g., 164) in the access command. However, the low level data storage in the namespace represented by the identifier 163 can be at a block size (e.g., 2^{n+m} bytes) (e.g., for improved ECC efficiency).

The host system 102 can use the access command 160 to access at the sub block level, as if the data were stored in the namespace at the granularity of the sub block size 188.

Optionally, the namespace represented by the identifier 163 can also be reconfigured to be accessed at a block level with each LBA address 164 having the size of a block (e.g., 2^{n+m} bytes). After the namespace represented by the identifier 163 is reconfigured to have an LBA data size that is equal to the size of a full block 131, the same access command 160 can be used to access a block (e.g., 131) without the sub block access manager 113 performing translation/mapping between block and sub block.

The access command 160 can have a plurality of predefined fields, such as command identifier 161, opcode 162, namespace identifier 163, LBA address 164, metadata pointer 165, data pointer 166, etc.

For example, predefined fields can be in compliance with a version of NVMe standard (e.g., base specification version 2.0). Command identifier 161 can be configured to specify an identifier of the command 160 such that the identifier is to uniquely identify the command 160 among commands currently provided by the host system 102 to the memory sub-system 101 for execution. The opcode 162 can be configured to specify whether the command 160 is to be executed to read data or to write data (or another operation). The namespace identifier 163 can be configured to specify the namespace 121 for the interpretation of the LBA address 164. The LBA address 164 identifies, in the namespace 121, a logical block having the logical block size currently defined for the namespace represented by the identifier 163. For example, the logical block size or data size of the LBA address 164 can be defined via a format NVM command 195 as in FIG. 6, as discussed further below. The metadata point 165 can be configured to provide an address of physical buffer of metadata or an address for an SGL segment. The data pointer 166 can be configured to provide an entry used for data transfer, such as an entry to facilitate data transfer via physical region page (PRP) or via scatter gather lists (SGL).

In some implementations, the memory sub-system 101 is pre-configured to have an LBA data size that is equal to a sub block size 188 for each sub block (e.g., 133, 135) stored at a block level in the memory cell array 141 in the memory sub-system 101.

In some implementations, the host system 102 can send commands to the memory sub-system 101 to change between a block-sized LBA data size and a sub block-sized LBA data size (e.g., using a command as in FIG. 6) without changing the data storage and/or without erasing the data in the namespace represented by the identifier 163.

FIG. 4 shows a structure of identify namespace data according to one embodiment. For example, the identify namespace data of FIG. 4 can be transmitted from the memory sub-system 101 of FIG. 1 to the host system 102 of FIG. 1 to assist the host system 102 of FIG. 1 in identifying an efficient way to access data in the memory sub-system 101.

For example, in response to an identify command from the host system 101 to the memory sub-system 101, the memory sub-system 101 can provide the identify namespace data 180 to indicate supported LBA formats in the memory sub-system 101.

For example, the identify command and the identify namespace data 180 can be substantially in compliance with an NVM express NVM command set specification, revision 1.0a. However, such a specification requires an LBA data size to be equal to or larger than 512=2⁹ bytes. In contrast, the identify namespace data 180 of FIG. 4 is configured to identify sub block size 188 that is smaller than 512=2⁹ bytes for sub block access without formatting the data in underlying storage at the sub block size 188 for the namespace.

For example, when the identify command from the host system 101 is directed to a predetermined namespace identifier (e.g., FFFFFFFFh), the memory sub-system 101 can provide the identify namespace data 180 to present the number 185 of LBA formats supported by the controller 113 of the memory sub-system 101 and a corresponding list of format supports (e.g., 187, 189).

For example, when the identify command from the host system 101 is directed to an active namespace (e.g., represented by a namespace identifier 163 usable in an access command 160), the identify namespace data 180 can further present attributes of the namespace in additional fields, such a formatted LBA size 184. In one embodiment, the formatted LBA size 184 is configured to identify a format among the number 185 of format supports (e.g., 187, 189) listed in the identify namespace data 180.

Optionally, when the identify command from the host system 101 is directed to an active namespace (e.g., represented by a namespace identifier 163 usable in an access command 160) that is configured to provide sub block level access, the identify namespace data 180 is configured to identify both the current sub block-level LBA data size (e.g., via the field formatted LBA 184), and the underlying block-level LBA data size (e.g., via the LBA format 0 support 187).

When the identify command identifies an active namespace (e.g., having the identifier 163), the memory sub-system 180 can provide the identify namespace data 180 specific to the active namespace, including the namespace size 181, the namespace capacity 182, the namespace utilization 183, the number 185 of LBA formats supported by the memory sub-system 101, and a list of format supports (e.g., 187, 189).

Each of the LBA format supports (e.g., 187 or 189) can have a structure as in FIG. 5. FIG. 5 shows an LBA format data according to one embodiment. The LBA format data 190 of FIG. 5 can have a predetermined size for inclusion in a field in the identify namespace data 180 in FIG. 4 (e.g., LBA format support 187 or 189).

The LBA format data 190 of FIG. 5 can have predetermined fields, such as relative performance indicator 191, LBA data size 193, etc.

The relative performance indicator 191 indicates whether use of the format can offer best performance, better performance, good performance, or degraded performance in the memory sub-system 102, relative to the use of other LBA formats supported by the controller 113 and identified in the identify namespace data 180.

The LBA data size 193 can be specified via an integer k to indicate a size of 2k bytes, where k can be from 1 to 9 or larger. When k is smaller than 9, the format is for sub block access and is not used to format the underlying data storage in the memory cell array 141. The memory sub-system 101 is configured to store data for ECC operations at a block size that is at least 512 bytes.

FIG. 6 shows a format NVM command according to one embodiment. For example, the command of FIG. 6 can be used to change the LBA data size of a namespace in the memory sub-system 101 in FIG. 1 to switch between accessing the namespace at a block level and accessing the same namespace at a sub block level.

In FIG. 6, the format NVM command 195 can include predefined fields for a namespace identifier 163 and a format identifier 197.

The namespace identifier 163 identifies a namespace of storage space allocated in the memory sub-system 101, where LBA addresses are defined sequentially, starting from zero.

The namespace identifier 197 is configured to identify an LBA format (e.g., 187, 189) supported by the memory sub-system 101 (e.g., as reported by the memory sub-system 101 via the identify namespace data 180 of FIG. 4).

For example, when the format identifier 197 identifies a format having an LBA data size 193 that is no smaller than 512 bytes (e.g., block size 186), the format NVM command 195 can be in compliance with an NVMe standard (e.g., NVM express NVM command set specification, revision 1.0a and NVM express base specification, revision 2.0d). The host system 101 can use such a command to low level format the NVM media (e.g., memory cell array 141) of the memory sub-system 101 to store data at a block-size level with ECC protection.

When the format identifier 197 identifies a format having an LBA data size 193 that is smaller than 512 bytes (e.g., sub block size 188), the execution of the format NVM command 195 causes the memory sub-system 101 to configure the sub block access manager 113 to provide sub block access at the LBA data size 193 without changing the low level format of the NVM media (e.g., memory cell array 141) of the memory sub-system 101.

Thus, after formatting the namespace having the identifier 163 using a format (e.g., 187) at a block size 186, the host system 102 can send the command 195 with an identifier 197 of a sub block-sized format 189 to change the LBA data size of the namespace to a sub block size 188 and thus to access the namespace in a way as illustrated in FIG. 2. Subsequently, the host system 102 can optionally send the command 195 with an identifier 197 of the block-sized format 187 to change the LBA data size of the namespace back to the block size 186 to access the namespace at the previously block-level formatted LBA data size. When the memory sub-system 101 determines that the block-sized format 187 is the same as the low level format of the NVM media (e.g., memory cell array 141) used in storing data in the memory sub-system 101 for the namespace, the memory sub-system 101 can stop the block to sub block translation operations of the sub block access manager 113 and allow the host system 102 to access the data previously stored in the memory cell array 141 at the block level.

Therefore, the host system 102 can use the format NVM command 195 (or another similar command) to switch between accessing the same namespace represented by the identifier 163 at an LBA data size 193 corresponding to the block size 186 and accessing at an LBA data size 193 corresponding to the sub block size 188.

Optionally, the memory sub-system 101 can be configured to support a plurality of formats having sub block sizes (e.g., 188) that are smaller than 512 bytes. The host system 101 can use the format NVM command 195 to change the data size of an LBA address in the namespace represented by the identifier 163 among the sub block sizes and the block size 186, while the data storage in the memory cell array 141 (and ECC operations of the error correction circuit 129) remains at the same block level without changes.

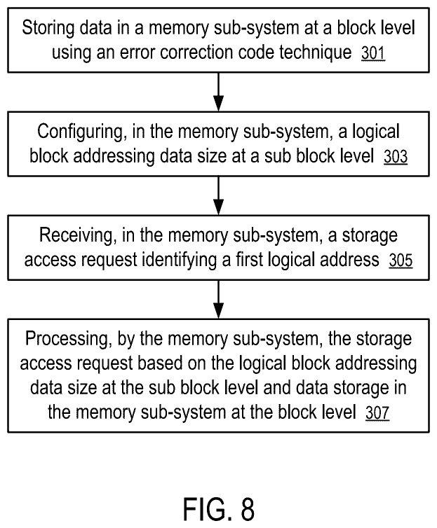

FIG. 7 illustrates an example of changing data size of LBA to facilitate sub block access according to one embodiment. For example, the scenario of FIG. 7 can be implemented in a computing system 100 of FIG. 1 to use the technique of FIG. 2.

In FIG. 7, the host system 102 sends an identify command 201 to the memory sub-system 101 to obtain identify namespace data 180 (e.g., as in FIG. 4).

The identify namespace data 180 can indicate whether the memory sub-system 101 supports LBA data sizes at sub block levels.

For example, if the LBA format supports (e.g., 187, 189) identified in the identify namespace data 180 includes one or more format supports (e.g., 189) having an LBA data size 193 that corresponds to a sub block size (e.g., smaller than 512 bytes), the memory sub-system 101 supports sub block access in a way as in FIG. 2 via setting LBA data size. Otherwise, the memory sub-system 101 may not support the technique of FIG. 2.

The host system 102 can send a format NVM command 203 to format a namespace at a block size 186 using a block-sized LBA format support (e.g., 187) identified in the identify namespace data 180.

After formatting the namespace at the block level, the host system 102 can optionally write data to the namespace using access commands that use LBA addresses having an LBA data size equal to the block size 186. For example, the host system 102 can store a block 131 of data in its memory 106 and send a write command containing an LBA address to cause the memory sub-system 101 to retrieve the entire block 131 over the connection/bus 107 for programming into the memory cell array 141 as the error correction protected block 132 containing a plurality of sub blocks (e.g., 133, 135).

Subsequently, the host system 102 can send another format NVM command 205 to change the LBA data size of the namespace to the sub block size 188 without changing or destroying the underlying stored data as in a way formatted via the format NVM command 203. In response to the format NVM command 205 specifying an LBA data size that is equal to the sub-block size 188 and is smaller than 512 bytes, the memory sub-system 101 activates the sub block access manager 113 to enable sub block access using the technique of FIG. 2.

For example, the host system 102 can subsequently send a read command 207 (e.g., in accordance with the access command 160 of FIG. 3) to the memory sub-system 102. In response, the memory sub-system 102 can provide a sub block 135 as identified via the LBA address 164 in the read command 207 in a way as in FIG. 2. The memory sub-system 102 can send the sub block 135 of the block 131 from its random access memory 127 over the connection/bus 107 to the memory 106 of the host system 102 without sending any portion of the block 131 outside of the sub block 135.

In a similar way, a sub block (e.g., 135) can be written from the host system 102 to the memory sub-system 101 while the namespace is configured to have an LBA data size that is equal to the sub block size 188.

Optionally, after the sub block level accesses made via the use of the format NVM command 205 and the technique of FIG. 2, the host system 102 can send the format NVM command 203 again to return the LBA data size of the namespace from the sub block size 188 to the block size 186. In response, the memory sub-system 101 can deactivate the sub block access manager 113; and the host system 102 can continue accessing the namespace, as if the format NVM command 205 had not been used.

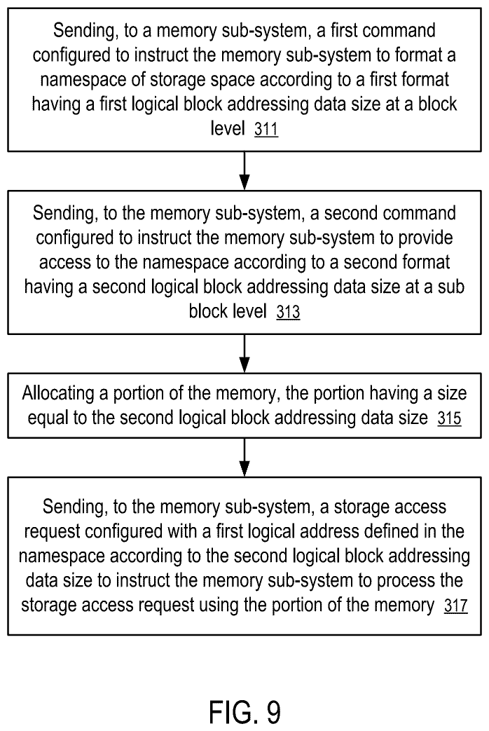

FIG. 8 to FIG. 9 show methods for sub block access according to some embodiments.

FIG. 8 to FIG. 9 show methods for sub block access according to some embodiments. The methods of FIG. 8 to FIG. 9 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the methods of FIG. 8 to FIG. 9 are performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the methods of FIG. 8 to FIG. 9 can be implemented using the sub block access managers 113 of FIG. 1 to perform the operations illustrated in FIG. 2 to FIG. 7.

At block 301, the method of FIG. 8 includes storing data in a memory sub-system 101 at a block level using an error correction code technique.

For example, the error correction code technique can be implemented in the error correction circuit 129 of the memory sub-system 101. To store a block 131 of data into the memory cell array 141, the error correction circuit 129 can generate redundant data for storing with the block 131 of the data as an error correction protected block 132. To apply the error correction code technique in detecting and correcting random bit errors in data retrieved from the error correction protected block 132, the content of the entire block 132 is to be retrieved and provided as input to the error correction circuit 128. In general, the error correction circuit 129 cannot perform decoding using only a portion of the block 132 without significant degradation in its error detection and correction capability.

At block 303, the method includes configuring, in the memory sub-system 101, a logical block addressing data size (e.g., 184) at a sub block level.

At block 305, the method includes receiving, in the memory sub-system 101, a storage access request 121 identifying a first logical address 125.

At block 307, the method includes processing, by the memory sub-system 101, the storage access request 121 based on the logical block addressing data size 184 at the sub block level and data storage in the memory sub-system 101 at the block level.

For example, the first logical address 125 is configured in a namespace (e.g., represented by a namespace identifier 163) allocated from a storage space of the memory sub-system 101. The logical block addressing data size 184 identifies a size of a storage space addressed by the first logical address 164. The method can further include receiving, from the host system 102, an identify command 201; and sending, by the memory sub-system 101 to the host system 102 in response to the identify command 201, identify namespace data 180 configured to identify a plurality of logical block addressing formats, including a first format 187 having a first logical block addressing data size 186 at the block level and a second format 189 having a second logical block addressing data size 188 at the sub block level.

For example, the configuring of the logical block addressing data size 184 at the sub block level can be via executing a command 205 to format the namespace using the second format 189.

For example, the method can further include: formatting the namespace represented by the identifier 163 using the first format 187 before formatting the namespace using the second format 189. The executing of the command 205 to format the namespace using the second format 189 is performed without changing data storage for the namespace in the memory cell array 141 formatted according to the first format 187.

For example, the first logical block addressing data size is no smaller than 512 bytes for the storage space represented by each LBA address (e.g., 137); and the second logical block addressing data size is smaller than 512 bytes for the storage space represented by each LBA address (e.g., 125).

For example, the processing of the storage access request 121 can be based on the logical block addressing data size 184 of the namespace, represented by the identifier 163, being configured according to the second format (e.g., 189).

For example, the method can further include: determining, from the first logical address 125, a second logical address 137 defined in the namespace (e.g., represented by the namespace identifier 163) according to an LBA data size that is equal to the first logical block addressing data size 186; retrieving, according to the second logical address 137 and from a memory cell array 141 of the memory sub-system 101, first data (e.g., content of the block 132) encoded using the error correction code technique; and decoding, by the error correction circuit 129 of the memory sub-system 101 using the error correction code technique, the first data into a random access memory 127 in the memory sub-system 101 as second data (e.g., content of the block 131) having a size that is equal to the first logical block addressing data size 188. The memory sub-system 101 can process the storage access request 121 processed based at least in part on the second data in the random access memory 127.

For example, when the storage access request 121 includes an opcode 162 for a read operation, the method can further include: extracting, from the second data in the block 131 in the random access memory 127, a portion (e.g., sub block 135) having a size that is equal to the second logical block addressing data size 188; and transmitting, from the memory sub-system 101 over a connection/bus 107 (e.g., PCIe bus) to the host system 102, the portion (e.g., sub block 135) without transmitting data (e.g., sub block 133) that is from outside of the portion in the second data in the block 131.

For example, when the storage access request 121 includes an opcode 162 for a write operation, the method can further include: retrieving, to the memory sub-system 101 from a memory 106 of the host system 102, third data having a size that is equal to the second logical block addressing data size 188; and modifying a portion of the second data in the block 181 in the random access memory 127 using the third data.

Since the data being transferred over the bus 107 between the host system 102 and the memory sub-system 101 is configured via the LBA size 184 to be equal to the size of a sub block (e.g., 135), read amplification and memory amplification can be reduced or eliminated.

The method of FIG. 9 can be performed in connection with the method of FIG. 8.

At block 311, the method of FIG. 9 includes sending, from the host system 102 to a memory sub-system 101, a first command 203 configured to instruct the memory sub-system 101 to format a namespace (e.g., represented by the identifier 163) of storage space according to a first LBA format 187 having a first logical block addressing data size 186 at a block level (e.g., no smaller than 512 bytes).

In response, the memory sub-system 101 can be configured to store (e.g., at block 301) data at the block level using the error correction code technique.

At block 313, the method includes sending, from the host system 102 to the memory sub-system 101, a second command 205 configured to instruct the memory sub-system 101 to provide access to the namespace (e.g., represented by the identifier 163) according to a second LBA format 189 having a second logical block addressing data size 188 at a sub block level (e.g., smaller than 512 bytes).

At block 315, the method includes allocating, by the host system 102, a portion of the memory 106, where the portion has a size equal to the second logical block addressing data size 188.

At block 317, the method includes sending, to the memory sub-system, a storage access request 201 configured with a first logical address 125 defined in the namespace (e.g., represented by the identifier 163) according to the second logical block addressing data size 188 to instruct the memory sub-system 101 to process the storage access request 121 using the portion of the memory 106.

In response, the memory sub-system 101 can be configured to process (e.g., at block 307) the storage access request 121 based on the logical block addressing data size 184 configured via the second command 205 at the sub block level and data storage in the memory sub-system 101 configured via the first command 207 at the block level.

For example, the first command 203 is configured to cause the memory sub-system 101 to store data in a memory cell array 141 at the block level according to the first logical block addressing data size 186; and the second command 205 is configured to cause the memory sub-system 101 to provide access at the sub block level according to the second logical block addressing data size 188 without changing data storage in the memory cell array 141 as configured via the first command 203 at the block level.

For example, the processing device 118 of the host system 102 can be further configured to: send, to the memory sub-system 101, an identify command 201 according to a non-volatile memory express protocol (e.g., NVM express NVM command set specification, revision 1.0a and NVM express base specification, revision 2.0d); and receive, from the memory sub-system 101, identify namespace data 180 (e.g., as in FIG. 4) configured to present the first format 187 and the second format 189.

For example, both the first command 203 and the second command 205 are format NVM commands (e.g., 195), according to the non-volatile memory express protocol, with different format identifiers (e.g., 197).

For example, the processing device 118 of the host system 102 can be further configured to: send a command to write, before sending the second command 205, first data (e.g., content of the block 132) to the namespace having the identifier 163 based on a logical block addressing data size 184 of the namespace being configured via the first command 203 to be equal to the first logical block addressing data size 186. As a result, the memory sub-system 101 stores an error correction protected version of the first data (e.g., block 132) at the block level. Subsequently, the storage access request 121 can be configured to cause the memory sub-system 101 to replace a sub block (e.g., 133 or 135), of the first data and having a size equal to the second logical block addressing data size 188, with data (e.g., replacement for the sub block 133 or 135) provided in the portion of the memory 106.

For example, the processing device 118 of the host system 102 can be further configured to: write, before sending the second command 205, first data (e.g., content of the block 132) to the namespace having the identifier 163 based on a logical block addressing data size 184 of the namespace being configured via the first command 203 to be equal to the first logical block addressing data size 186. As a result, the memory sub-system 101 stores an error correction protected version of the first data (e.g., block 132) at the block level. Subsequently, the storage access request 121 is configured to cause the memory sub-system 101 to retrieve a sub block 135, of the first data and having a size equal to the second logical block addressing data size 188, from the memory sub-system 101 into the portion of the memory 106.

Optionally, the host system 101 can send, to the memory sub-system 102 and after sending the second command 205, a third command configured to identify the first logical block addressing data size 186 at the block level; and in response, the memory sub-system 101 can change the LBA size 184 of the namespace back to the first logical block addressing data size 186 and thus configure access to the namespace at the first logical block addressing data size 186, without changing the data storage in the memory cell array 141 (e.g., a non-volatile memory, a flash memory) for the namespace that has been at the block level since the execution of the first command 203.

For example, each of the first command 203, the second command 203, and the third command can be a format NVM command 195 according to an NVM express protocol with a format identifier 197 set to identify a format (e.g., 187 or 189) reported in the identify namespace data 180.

A non-transitory computer storage medium can be used to store instructions programmed to implement the sub block access managers 113 in the host system 102 and the memory sub-system 101. When the instructions are executed by the processing device 118, the controller 115, and the processing device 117, the instructions cause the host system 102 and/or the memory sub-system 101 to perform the methods discussed above.

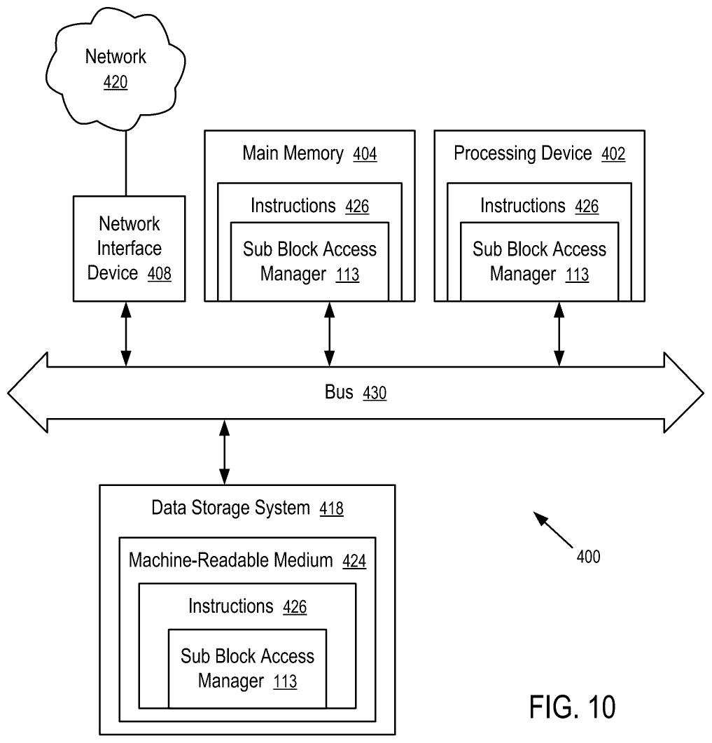

FIG. 10 illustrates an example machine of a computer system 400 within which a set of instructions, for causing the machine to perform any one or more of the methodologies discussed herein, can be executed. In some embodiments, the computer system 400 can correspond to a host system (e.g., the host system 102 of FIG. 1) that includes, is coupled to, or utilizes a memory sub-system (e.g., the memory sub-system 101 of FIG. 1) or can be used to perform the operations of sub block access managers 113 (e.g., to execute instructions to perform operations corresponding to the sub block access managers 113 described with reference to FIGS. 1-9). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 418, which communicate with each other via a bus 430 (which can include multiple buses).

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable medium 424, data storage system 418, and/or main memory 404 can correspond to the memory sub-system 101 of FIG. 1.

In one embodiment, the instructions 426 include instructions to implement functionality corresponding to the sub block access managers 113 described with reference to FIGS. 1-9. While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
storing data in a memory sub-system at a block level using an error correction code technique;
configuring, in the memory sub-system, a logical block addressing data size at a sub block level;
receiving, in the memory sub-system, a storage access request identifying a first logical address; and
processing, by the memory sub-system, the storage access request based on the logical block addressing data size at the sub block level and data storage in the memory sub-system at the block level.

2. The method of claim 1, wherein the first logical address is configured in a namespace allocated from a storage space of the memory sub-system; the logical block addressing data size identifies a size of a storage space addressed by the first logical address; and the method further comprises:
receiving, from a host system, an identify command; and
sending, by the memory sub-system to the host system in response to the identify command, identify namespace data configured to identify a plurality of logical block addressing formats, including a first format having a first logical block addressing data size at the block level and a second format having a second logical block addressing data size at the sub block level.

3. The method of claim 2, wherein the first logical block addressing data size is no smaller than 512 bytes; and the second logical block addressing data size is smaller than 512 bytes.

4. The method of claim 3, wherein the processing of the storage access request is based on the logical block addressing data size of the namespace being configured according to the second format.

5. The method of claim 4, further comprising:
determining, from the first logical address, a second logical address defined in the namespace according to a data size that is equal to the first logical block addressing data size;
retrieving, according to the second logical address and from a memory cell array of the memory sub-system, first data encoded using the error correction code technique; and
decoding, using the error correction code technique, the first data into a random access memory in the memory sub-system as second data having a size that is equal to the first logical block addressing data size;
wherein the storage access request is processed based at least in part on the second data in the random access memory.

6. The method of claim 5, wherein the storage access request includes an opcode for a read operation; and the method further comprises:
extracting, from the second data, a portion having a size that is equal to the second logical block addressing data size; and
transmitting, from the memory sub-system to the host system, the portion without transmitting data that is from outside of the portion in the second data.

7. The method of claim 5, wherein the storage access request includes an opcode for a write operation; and the method further comprises:
retrieving, to the memory sub-system from the host system, third data having a size that is equal to the second logical block addressing data size; and
modifying a portion of the second data in the random access memory using the third data.

8. The method of claim 5, wherein the configuring of the logical block addressing data size at the sub block level is via executing a command to format the namespace using the second format.

9. The method of claim 8, wherein the method further comprises:
formatting the namespace using the first format before formatting the namespace using the second format, wherein the executing of the command to format the namespace using the second format is performed without changing data storage for the namespace in the memory cell array formatted according to the first format.

10. A host system, comprising:
a memory; and
a processing device configured to:
send, to a memory sub-system, a first command configured to instruct the memory sub-system to format a namespace of storage space according to a first format having a first logical block addressing data size at a block level;
send, to the memory sub-system, a second command configured to instruct the memory sub-system to provide access to the namespace according to a second format having a second logical block addressing data size at a sub block level;
allocate a portion of the memory, the portion having a size equal to the second logical block addressing data size; and
send, to the memory sub-system, a storage access request configured with a first logical address defined in the namespace according to the second logical block addressing data size to instruct the memory sub-system to process the storage access request using the portion of the memory.

11. The host system of claim 10, wherein the first logical block addressing data size is no smaller than 512 bytes; and the second logical block addressing data size is smaller than 512 bytes.

12. The host system of claim 11, wherein the first command is configured to cause the memory sub-system to store data in a memory cell array at the block level according to the first logical block addressing data size; and the second command is configured to cause the memory sub-system to provide access at the sub block level according to the second logical block addressing data size without changing data storage in the memory cell array at the block level as configured via the first command.

13. The host system of claim 12, wherein the processing device is further configured to:
send, to the memory sub-system, an identify command according to a non-volatile memory express protocol; and
receive, from the memory sub-system, identify namespace data configured to present the first format and the second format.

14. The host system of claim 13, wherein the non-volatile memory express protocol is an NVM express base specification and an NVM express NVM command set specification; and both the first command and the second command are format NVM commands.

15. The host system of claim 13, wherein the processing device is further configured to:
write, before sending the second command, first data to the namespace based on a logical block addressing data size of the namespace being configured to be equal to the first logical block addressing data size;
wherein the storage access request is configured to cause the memory sub-system to replace a sub block, of the first data and having a size equal to the second logical block addressing data size, with data provided in the portion of the memory.

16. The host system of claim 13, wherein the processing device is further configured to:
write, before sending the second command, first data to the namespace based on a logical block addressing data size of the namespace being configured to be equal to the first logical block addressing data size;
wherein the storage access request is configured to cause the memory sub-system to retrieve a sub block, of the first data and having a size equal to the second logical block addressing data size, from the memory sub-system into the portion of the memory.

17. A non-transitory computer storage medium storing instructions which, when executed in a computing system having a host system connected to a memory sub-system via a computer bus, cause the computing system to perform a method, comprising:
sending, from the host system to the memory sub-system, a first command configured to identify a first logical block addressing data size at a block level;
formatting, by the memory sub-system in response to the first command, data storage for a namespace in a non-volatile memory at the block level;
sending, from the host system to the memory sub-system, a second command configured to identify a second logical block addressing data size at a sub block level; and
configuring, by the memory sub-system in response to the second command, access to the namespace at the second logical block addressing data size without changing the data storage in the non-volatile memory for the namespace at the block level.

18. The non-transitory computer storage medium of claim 17, wherein the method further comprises:
sending, from the host system to the memory sub-system, a storage access request while the namespace is configured to provide access at the second logical block addressing data size;
determining, by the memory sub-system from a first logical address provided in the storage access request, a second logical address defined in the namespace according to a data size that is equal to the first logical block addressing data size;
retrieving, by the memory sub-system according to the second logical address and from the non-volatile memory, first data encoded using an error correction code technique;
decoding, by the memory sub-system using the error correction code technique, the first data into a random access memory in the memory sub-system as second data having a size that is equal to the first logical block addressing data size; and
generating, by the memory sub-system, a response to the storage access request based at least in part on the second data in the random access memory.

19. The non-transitory computer storage medium of claim 18, wherein the method further comprises:
sending, by the host system to the memory sub-system, an identify command according to a NVM express protocol; and
sending, by the memory sub-system to the host system in response to the identify command, identify namespace data configured to identify the first logical block addressing data size that is no smaller than 512 bytes and the second logical block addressing data size that is smaller than 512 bytes.

20. The non-transitory computer storage medium of claim 19, wherein the method further comprises:
sending, from the host system to the memory sub-system, a third command configured to identify the first logical block addressing data size at the block level; and
configuring, by the memory sub-system in response to the third command, access to the namespace at the first logical block addressing data size without changing the data storage in the non-volatile memory for the namespace at the block level;
wherein each of the first command, the second command, and the third command is a format NVM command according to the NVM express protocol.
